(19) United States
(12) Patent Application Publication
(10) Pub. No.: US 2014/0102484 A1
(43) Pub. Date: Apr. 17, 2014

(54) DRYING DEVICE FOR CONTAINERS AND METHOD FOR CLEANING SUCH A DRYING DEVICE

(71) Applicant: Stefan SCHOBER, Tegernheim (DE)

(72) Inventor: Stefan SCHOBER, Tegernheim (DE)

(73) Assignee: KRONES AG, Neutraubling (DE)

(21) Appl. No.: 13/649,778

(22) Filed: Oct. 11, 2012

(51) Int. Cl. B08B 9/093; F26B 19/00

(52) U.S. Cl. 134/22.1; 34/85

(57) ABSTRACT

A device for drying containers, especially bottles, includes a substantially closed drying chamber, with an inlet opening, an outlet opening, and a transport system for the containers. The containers are transported through the drying chamber standing in an upright position. An air supply opening supplies drying air. At least one cleaning device chemically and or mechanically cleans the interior of the drying chamber, whereby a cleanser and/or a disinfectant can be injected into the interior of the drying chamber, distributed inside the drying chamber and removed from the drying chamber through the cleaning device.

A method for cleaning a device for drying containers, whereby the at least one cleanser and/or disinfectant is injected into the interior of the drying chamber, distributed inside the drying chamber and removed from the drying chamber through the cleaning device.

This claims the benefit of German Patent Application DE 10 2011 054 683.9, filed Oct. 21, 2011 and hereby incorporated by references herein.

The present invention relates to a drying device for containers, especially for bottles. The invention furthermore relates to a method for cleaning such a drying device.

### BACKGROUND

During the manufacturing, filling and/or packaging of containers, particularly during manufacturing, filling and/or packaging of bottles in the beverage industry, it happens quite often that moisture adheres to the outside of the containers. As an example, the moisture often originates from liquid, which overflows during the filling of the containers. Furthermore, it may also be residual liquid, which still sticks to the containers after they have been cleaned. In addition, temperature fluctuations during processing can result in moisture condensing on the outside of the containers. Since this moisture can interfere with subsequent processing steps, it needs to be removed from the outer sides of the containers. Such subsequent processing steps can be, for example, the inspection of empty bottles, the inspection of filled bottles, the labeling of bottles etc. For this purpose, the containers are transported through so called drying modules, where the adhering moisture is blown off. The blown-off droplets of moisture collect in a catch basin. But often the blown-off droplets can also be found hanging on the inner side walls of the drying module.

A device for drying articles is described in DE 102008004774 A1. One drying chamber has air supply openings for supplying drying air and furthermore at least one discharge opening for discharging the exhaust humid air. In particular, this device is provided with an internal air flow, whereby the air flow is directed past the inlet opening and/or past the outlet opening, through which the articles to be dried enter and/or leave the drying chamber.

### SUMMARY OF THE INVENTION

Even with this directed guidance of the exhaust air flow, it cannot be excluded, that blown-off droplets collect at the side walls of the drying module. Especially in warm regions this leads to huge problems regarding the contamination of the drying module. In excellent wet and/or hot conditions a lot of germs easily accumulate and quickly multiply. To avoid an increased germ formation and germ load, the drying modules must therefore be cleaned regularly. Preferentially, the drying modules must be cleaned at least once a day. Conventionally the cleaning is performed manually, whereby the interior of the drying module is usually hosed with water, optionally treated with a detergent and subsequently hosed with water again. This process is quite time consuming. Additionally, this cleaning procedure is often very uncomfortable for the implementing operators and is especially acquainted with serious health risks. Since no production can be run during this cleaning time, the time intervals between subsequent cleanings of the drying chamber are often extended. This in turn creates a higher germ load for the operators of subsequent processing stations, since the growing conditions for the germs are improved.

It is an object of the present invention is to perform a simple, quick and inexpensive cleaning of drying modules.

The present invention provides a device for drying containers, especially a drying module for drying empty or full beverage bottles or the like in a container treatment plant and/or in a container filling plant. The device comprises a substantially closed drying chamber, comprising an inlet opening and an outlet opening for the containers to be dried. The containers are transported through the drying chamber in an upright position via a transport system. The device comprises at least one air supply opening for supplying drying air. Furthermore, the device comprises at least one air discharge opening for discharging the moist exhaust air. According to the invention, the device comprises at least one cleaning device for the chemical cleaning of the interior of the drying chamber or the device comprises at least one cleaning device for the chemical and mechanical cleaning of the interior of the drying chamber. A cleansing agent and/or a disinfectant can be injected into the interior of the drying chamber via the cleaning device. The cleansing agent and/or disinfectant is then distributed and removed again from the interior of the drying chamber through this cleaning device.

Neutral cleansing agents, for example cold water and/or hot water, can be used as cleansing agents and/or as disinfectants. Furthermore, special cleansing agents, especially alkaline cleansing agents, can be used. The use of acidic cleansing agents is also possible, as far as they do not attack the materials used in the interior of the drying chamber.

The cleaning device comprises at least one cleansing nozzle and/or a cleansing brush. In particular, a spraying ball, a deflection nozzle, a rotary nozzle, a jet nozzle or a double-jet nozzle can be used. Preferably the apparatus comprises a plurality of cleansing nozzles and/or brushes, whereby at least one cleansing nozzle and/or one cleansing brush is arranged in each of the corner regions of the drying chamber.

According to a preferred embodiment, the position of the cleansing nozzles and/or cleansing brushes is fixed inside the drying chamber. Preferably, the cleansing nozzles and/or cleansing brushes are also pivotally arranged within the interior of the drying chamber, so that complete flushing and cleaning of the interior of the drying chamber is possible by pivoting the cleansing nozzles and/or cleansing brushes during the cleansing process.

According to an alternative embodiment, rotating cleansing brushes are provided, which are movable attached to frame members or to cross-beam or transverse frame elements. Particularly, the cleansing brushes are in mounted to the frame elements in the interior of the drying chamber in such a way, that they are able to contact the surfaces to be cleaned. In particular, the cleansing brushes are in mounted to the frame elements in such a way, that they can contact the inner side walls of the drying chamber. The cleansing brushes can thereby scrape across the inner side walls and/or other areas to be cleaned, thereby improving the cleaning success. In addition to the chemical cleaning with water and/or with a suitable cleansing agent, the cleansing brushes provide a mechanical cleaning of the contacted surfaces. At least one reservoir with detergent and/or at least one connection to a water supply may be assigned to the cleaning device. The storage container or the water supply is connected to the cleansing nozzles and/or cleansing brushes via pipes. The cleansing agent and/or the water is supplied to the interior of the drying chamber through these pipes and is distributed inside the drying chamber through these pipes.

The cleaning process is preferably automated. Thereby the cleaning process is preferably controlled and monitored via a control unit. In particular, the cleaning cycle and/or the cleaning process are controlled by the control unit according to a predefined program. The program includes, for example, the information regarding the different cleaning steps. The control unit can also contain the appropriate information regarding, for example, at what time intervals the automatic cleaning of the interior of the drying chamber is required. Alternatively, the cleaning operation can be started manually by an operator via the control unit.

The control of the cleaning operation can thus take place via a control module, which is assigned to the drying module. However, it may also be provided that the control module is connected to a central, higher-level system, which coordinates the different modules of a container treatment plant. If, for example, the system must be at least partially converted due to a product change, the higher-level system activates the control unit. The cleaning intervals can thus be set individually over time. The cleaning intervals can also be programmed according to the beginning of the production, according to the end of the production etc., or the cleaning intervals can be set manually.

According to another embodiment, the inlet opening and outlet opening for the containers can be substantially sealed during the cleaning of the drying chamber by means of closure devices. Thereby the interior of the drying chamber forms a closed system. This is especially useful for preventing cleansing agent escaping from the interior of the drying chamber to the outside of the drying device during the cleaning process and thus polluting the environment of the device. Furthermore, the safety of the operator working on the drying device is improved. In particular, is can be prevented effectively, that the operator may come in contact with the harsh cleansing agents and/or with hot steam. In particular, it can be provided, that the closure devices are controlled by the control unit. The control unit especially controls the opening state of the closure devices before and after the cleaning process.

According to one embodiment of the invention, the closure devices are equipped with sealing elements. The sealing elements are attached to the closure devices in the peripheral region of their surfaces contacting the inlet opening and the outlet opening of the drying chamber. As sealing elements, in particular rubber lips and/or brush strips can be used. In particular, rugged areas in the region of the inlet opening and the outlet opening, such as the guide rails for the containers etc., can thus be better sealed off.

According to another embodiment, the cleaning process takes place automatically at predefined time intervals. The control unit interrupts the flow of the containers into the drying chamber before the beginning of the cleaning process. The containers, which are located in the interior of the drying chamber, are first conveyed out of the drying chamber through the outlet opening, before the cleaning procedure is started. This guarantees that there are no containers inside the drying chamber during the cleaning process. It may further be provided that the transport system continues to move during the cleaning process, ensuring that the entire transportation system is also cleaned sufficiently.

Additionally, the closure devices may be monitored by active locks or via door contacts. The cleaning process is only started by the control unit when the closure devices are closed and when there are no more containers in the interior of the drying chamber.

Furthermore, the apparatus may include a suction device for removing the cleansing agent. With the suction device the cleansing agent can be removed from the drying device separately and in a controlled manner. Furthermore, the drying chamber may be equipped with a viewing window. The viewing window allows the operator to monitor the functional state and/or the cleanliness of the interior of the drying chamber.

The invention further relates to a method for cleaning a drying device for drying containers. This method uses a cleaning device according to the invention, which has been described above. According to the invention at least one cleansing agent and/or disinfectant is introduced into the interior of the drying chamber via the cleaning device. During a cleaning cycle the different cleaning steps are preferably performed automatically and/or in a controlled way. Firstly, water is injected into the interior of the drying chamber to moisten the inner wall surfaces and to remove the coarsest impurities. Subsequently, a cleansing agent is injected into the interior of the drying chamber through the cleansing nozzles. In particular, detergent foam is injected into the interior of the drying chamber. Preferably, the cleansing agent can now act upon the surfaces inside the drying chamber for a defined time. For example, an exposure time of about 5 min to 10 min is scheduled. Thereafter, the detergent gets rinsed off by injecting water through the cleansing nozzles into the interior of the drying chamber. After repeated rinsing and blowing air through the at least one air supply opening, the operation of the drying device can resume. The blowing of air through the air supply opening is necessary to remove any detergent residue and/or any water, which has possibly penetrated into the air supply system of the drying device. Before production is resumed, more air can be blown through the cleansing nozzles to furthermore dry the interior of the drying chamber.

In particular, it can be provided, that water and/or cleansing agent is sucked off after each of the cleaning steps. Thereby it is possible, for example, to separately collect and recycle the cleansing agent. For example, a draining device can be integrated either in the bottom plate of the interior of the drying chamber or beside the bottom plate. The cleansing agent can thereby be collected and disposed of or the cleansing agent can be collected, recycled and reused. For example, a first draining device for water and a second draining device for the cleansing agent may be provided. If a cleaning step using water is carried out, the first draining device for water is opened and the second draining device for the cleansing agent is closed. If another cleaning step is carried out with cleansing agent, then the second draining device for the cleansing agent is opened and the first draining device for water is closed. Alternatively, a single draining device may be provided, which can be switched over to different ways of disposal. In particular, a plurality of drain pipes may be connected to this single draining device, each pipe leading to a separate collecting container. Depending on the respective cleaning step, the appropriate disposal pipe or the corresponding discharge pipe for water, alkaline cleansing agents, acidic cleansing agents, etc. is opened by means of a changeover valve. Meanwhile the other disposal pipes are each closed. The water or cleansing agents is thereby guided into the respective collecting container. The water or cleansing agent is subsequently removed from the collecting container and fed to a suitable reprocessing.

According to a preferred embodiment, air is blown continuously through the at least one air supply opening into the interior of the drying chamber during the whole cleaning process. This ensures that no water or cleansing agents enters the air supply system, thereby contaminating the air supply system. To save energy during the cleaning process, the power of the blower of the air supply system can be reduced during the cleaning process in comparison to the power of the blower providing the drying air during the container drying process. For example, only about 20% of the normal dry air volume per unit of time is blown into the interior of the drying chamber during the cleaning process.

The cleaning is preferentially done mechanically, through flushing or through spraying. The pressure, temperature and/or the amount of the cleansing agents is adjustable and controllable by the control unit. The pipes for the water and/or for the cleansing agents leading to the cleansing nozzles can be provided with flow switches and flow meters etc. This allows a better control of the supply of water and/or cleansing agents, thereby ensuring or guaranteeing the complete treatment of the interior of the drying chamber during the cleaning process.

It should also be noted that the term “chemical cleaning” is also used to describe the cleaning of the drying chamber using only water as a cleansing agent. For example, the term “chemical cleaning” is also used to describe the cleaning of the drying chamber with hot water vapor.

The automatic cleaning of the cleaning device can be operated independently from the general processing plant cleaning system. Alternatively the automatic cleaning of the cleaning device can be connected to the existing processing plant cleaning system. Thus, for example, common cleansing agent storage containers and/or a connection to a common water supply can be used.

The particular advantage of the automated cleaning is that no time-consuming manual cleaning through an operator is required. It furthermore guarantees that the cleaning of the drying device is performed at regular intervals. This effectively prevents a settlement of germs within the drying chamber, especially a growth of molds such as Aspergillus or the like. This leads to a substantial improvement of the sanitary conditions in such processing plants. Health risks for the operators working on the device by mold spores etc. can thus be minimized as much as possible.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows a schematic front view of a drying module for bottles according to the present invention.

FIGS. 2 to 4 each shows a schematic side view of the interior of a drying module for bottles according to the present invention.

FIGS. 5 to 8 each shows a further schematic front view of a drying module for bottles according to the present invention.

FIG. 9 schematically shows the different cleaning steps performed during a cleaning cycle.

### DETAILED DESCRIPTION

The same or equivalent elements of the invention are designated by identical reference characters. Furthermore and for the sake of clarity, only the reference characters relevant for describing the respective figure are provided. It should be understood that the embodiments described are only examples and they are not intended to limit the scope of the disclosure.

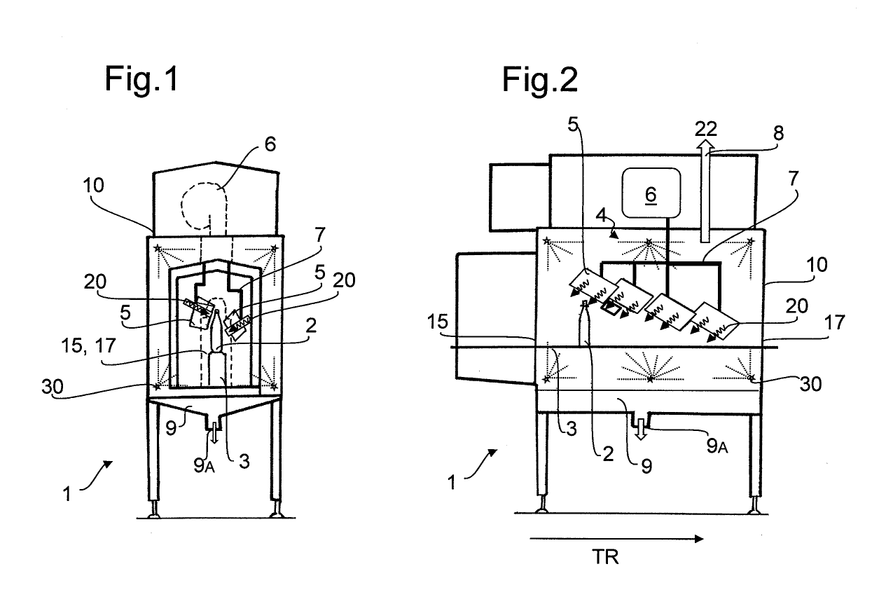

FIG. 1 to FIG. 5 each respectively show views of a drying module 1 for bottles 2 according to the present invention. The drying module 1 comprises a substantially closed drying chamber 10 with an inlet opening 15 and an outlet opening 17 for the bottles 2. The bottles 2 are transported through the drying chamber 10 on a transport means or transporter 3. Thereby the bottles 2 are standing in an upright position. For example, the transport means 3 can be a transport lane like a conveyor belt, whereby the bottles 2 traverse the drying chamber 10 in transporting direction TR. Especially the bottles 2 are arranged in a row and traverse the drying chamber 10 one behind the other.

An air supply system 4 is arranged above and/or beside the transport alley for the bottles 2. For example, drying air 20 is generated through a blower 6 and is then passed through air pipes 7 into the interior of the drying chamber 10. The drying air 20 is preferably blown obliquely downwards onto the bottles 2 through so-called air knifes 5. The blown-off moisture preferably accumulates in a draining pan 9, which comprises a drain 9A. The moist air 22 sucked off through an air removal opening 8, thereby removing it from the interior of the drying chamber 10.

The drying chamber 10 comprises at least one cleaning device, through which the cleansing agent can be injected into the interior of the drying chamber 10. In the illustrated embodiment, the cleaning device comprises a plurality of cleansing nozzles 30, wherein one cleansing nozzle 30 is arranged in each of the corners of the drying chamber 10. Furthermore, at least two cleansing nozzles 30 are arranged in a central region of the drying chamber 10. As cleansing nozzle 30 preferably spray balls, deflection nozzles, flat spray nozzles, dual-fan nozzles etc. are used. Preferably, the cleansing nozzles 30 are mounted pivotal and/or rotatable in all directions in space.

Instead of cleansing nozzles 30 cleansing brushes may also be used. Especially cleansing brushes with openings may be used, whereby the cleansing agent can be injected into the interior of the drying chamber 10 through the openings of the cleansing brushes.

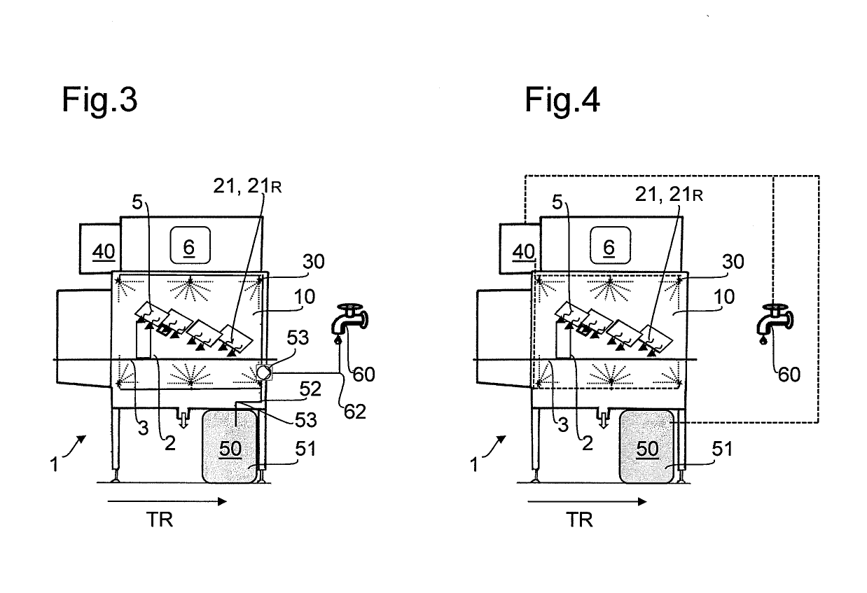

As shown in FIG. 3, at least one storage container 50 with cleansing agent 51 is associated with the cleaning device. In addition, the cleaning device comprises at least one access to a water supply 60. The cleansing agent 51 and/or water is passed through pipes 52, 62 to the cleansing nozzles 32 or brushes. Thereby the cleansing agent 51 and/or water can be distributed within the drying chamber 10. The cleansing agent 51 may, for example, be water. Special cleansing agents, especially alkaline cleansing agents, can be used for an improved cleaning result and/or disinfection result. Also a cleaning process using acidic cleansing agents may be possible, as far as the materials used in the interior of the drying chamber are not attacked by these acidic cleansing agent 51.

The cleaning of the interior of the drying chamber 10 is preferably automated. In particular, the different cleaning steps, the duration of the cleaning process and the intervals between two cleaning processes can be controlled. As shown in FIG. 4, a control device 40 is provided for this purpose. The control device 40 controls a pumping device 53, which is used to supply water, cleansing agent 51 or a mixture of water and cleansing agent 51 to the cleansing nozzles 30. Furthermore, the control device 40 also controls the cleansing nozzles 30 or cleansing brushes. The cleansing nozzles 30 or cleansing brushes are preferably arranged in a fixed position in the interior of the drying chamber 10. Especially the cleansing nozzles 30 or cleansing brushes may be, for example, fixed pivotal and/or rotatable. This allows a substantially uniform distribution of the water and/or cleansing agent 51 in the interior of the drying chamber 10 or on the inner side surfaces of the drying chamber 10. The cleaning is preferentially done automatically, especially according to certain pre-set time intervals. In this case, the control unit 40 interrupts the supply of bottles 2, which are fed into the drying chamber 10. This ensures that no bottles 2 are in the drying chamber 10 during the cleaning process. However, it can be provided, that the blank transport means 3 continues to move through the drying chamber 10 during the cleaning process. This allows a comprehensive cleaning of the transport means 3.

However, it can also be provided, that the cleaning process is started manually by an operator through the control device 40.

Preferably, air 21 is blown continuously into the interior of the drying chamber 10 through the air knifes 5 during the cleaning process. This prevents water and/or cleansing agent 51 getting into the air knifes 5 or into the air pipes 7 during the cleaning process. To save energy during the cleaning process, the power of the blower 6 can be reduced by about 80%, whereby the above described effect is still achieved.

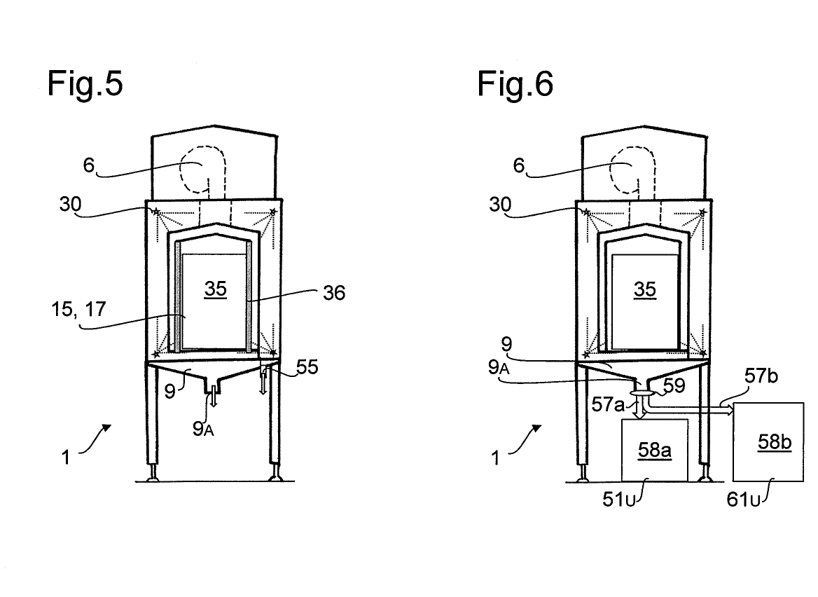

FIG. 5 shows special locking devices 35. They are associated with the inlet opening 15 and the outlet opening 17 for the containers. The inlet opening 15 and the outlet opening 17 can be closed with these locking devices 35 before the cleaning process starts. Thus the interior of the drying chamber 10 forms a fully enclosed space and no water and/or no cleansing agent 51 can reach the outside of the drying chamber 10. The locking devices 35 can comprise sealing elements 36. The sealing elements 36 are provided in areas, where the locking devices 35 are in direct contact with the openings 15, 17. Preferably, the locking devices 35 are provided with rubber lips and/or brush strips. Thus, for example, rugged parts such as rails for guiding the bottles in the input and output areas can be sealed off.

The locking devices 35 can be mounted manually. Preferably, the locking devices 35 are automatically adjustable and controlled by the control device 40. Thereby the inlet opening 15 and the outlet opening 17 for the containers can be closed automatically before the cleaning process starts. And furthermore the inlet opening 15 and the outlet opening 17 can be automatically re-opened after the cleaning process is finished. FIG. 5 also shows a suction device 55 for siphoning off water and/or cleansing agents 51. The suction device 55 is arranged in a lower lateral region of the drying chamber 10, allowing the cleansing agent 51 to be collected separately and furthermore allowing the recycling the cleansing agent 51 if desired.

According to FIG. 6, two draining pipes 57a, 57b are assigned to the drain 9A. Depending on the respective cleaning step, the desired type of disposal is selected via a switching valve 59. Thereby the desired draining pipe 57a or 57b is opened; meanwhile the other draining pipe 57b or 57a is closed. For example, the draining pipe 57a leads to a collecting reservoir 58a for used cleansing agent 51U. Accordingly, the drain pipe 57b leads to a collecting reservoir 58b for used water 61U. The spent cleansing agent 51U or the spent water 61U can then be removed from the respective reservoir 58a, 58b and is subsequently fed into a suitable reprocessing unit.

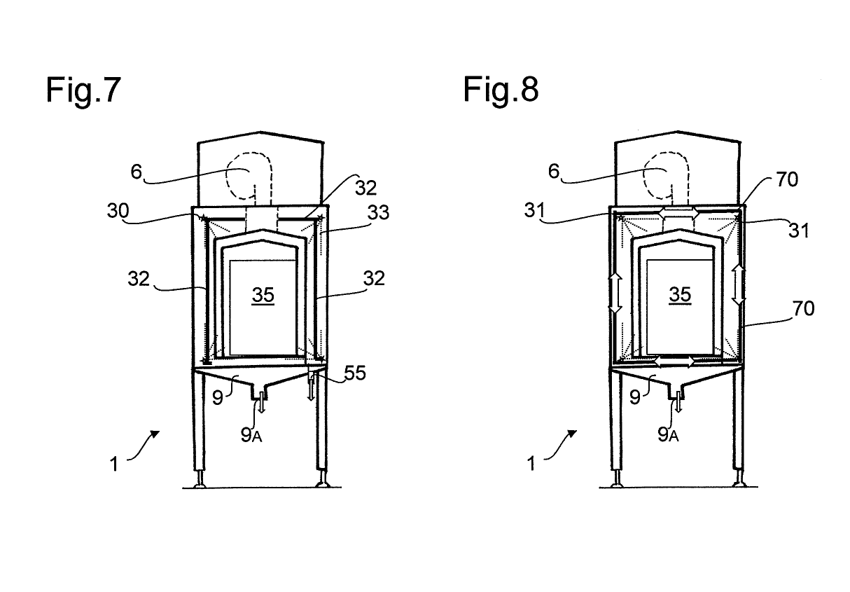

FIG. 7 shows a further air flow system. In order to complete the cleaning process, the interior of the drying chamber 10 has to be dried. Only then the drying of containers 2 can be resumed. Therefore it can be provided that the required drying air 22 is injected through the existing air flow system 4 (see FIG. 2). Alternatively and/or additionally air 33 may also be injected into the drying chamber 10 through the air cleansing nozzles 30. The cleansing nozzles 30 are therefore connected to air pipes 32. The air pipes 32 are connected, for example, with the blower 6 for the drying air 22 or the air pipes 32 are connected to a separate blower.

According to an alternative embodiment shown in FIG. 8, rotating cleansing brushes 31 are provided inside the drying chamber 10. The rotating cleansing brushes 31 are used instead of the previously described cleansing nozzles. The position of the rotating cleansing brushes 31 inside the drying chamber 10 can be changed. The cleansing brushes 31 are movably arranged on a frame structure, which comprises vertical and horizontal transverse elements 70. Thereby the cleansing brushes 31 can contact the inner side walls of the drying chamber 10. And/or the cleansing brushes 31 can contact other areas inside drying chamber 10, which need to be cleaned. For example, the cleansing brushes 31 can contact the transport means (not shown) or similar. Thereby these surfaces can be cleaned mechanically.

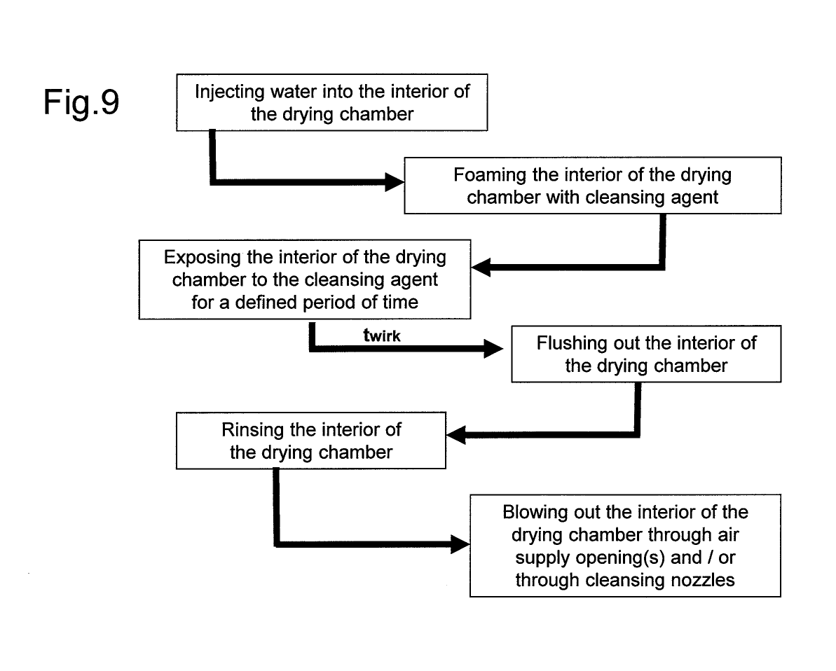

FIG. 9 schematically illustrates the cleaning steps during a cleaning cycle. Firstly, water is injected through the cleansing nozzles into the drying chamber. Thereby the inner surfaces inside the drying chamber are moistened and coarse surface impurities are removed. Subsequently, the interior of the drying chamber is foamed with a cleansing agent and/or with a disinfectant. The cleansing agent and/or disinfectant is also injected into the drying chamber through the cleansing nozzles. Preferably, the interior of the drying chamber is now exposed to the action of the cleansing agent and/or of the disinfectant for a certain time t_{wirk}. The exposure time t_{wirk} is, for example, about 5 min to 10 min. The cleansing agent and/or disinfectant can now be drawn off first. Alternately, the cleansing agent and/or disinfectant can be flushed off directly by injecting water into the interior of the drying chamber through the cleansing nozzles. Preferably, any residual cleansing agent and/or disinfectant is removed completely by rinsing it off with water. In a final cleaning step, the interior of the drying chamber is blown dry. This can be done via the air supply openings, through which the drying air is usually blown into the drying chamber. On the other hand, the necessary air can also be blown into the interior of the drying chamber through the cleansing nozzles.

The invention has been described with reference to preferred embodiments. To the expert it is also conceivable, however, to make changes and modifications without leaving the scope of protection of the appended claims.

### LIST OF REFERENCE NUMBERS

1 drying module
2 Bottle
3 transport means
4 air flow system/air supply system
5 air knife
6 Blower
7 air pipe
8 air removal opening
9 draining pan
9A drain
10 drying chamber
15 inlet opening
17 outlet opening
20 drying air
21 air
21R air with reduced blower power
22 moist air
30 cleansing nozzle
31 cleaning brush
32 air pipe
35 locking device
36 sealing element
40 control unit
50 reservoir
51 cleansing agent
51U used/spent cleansing agent
53 pumping means
55 suction means
57a/57b draining pipe
58a/58b collecting reservoir
60 water supply
61U used/spent water
62 water pipe
70 transverse element
t_{wirk} exposure time

What is claimed is:

1. A device for drying containers, the device comprising:
a substantially closed drying chamber having an inlet opening and an outlet opening for the containers;
a transport system for the containers, the containers being transported through the drying chamber standing in an upright position;
at least one air supply opening for supplying drying air; and
at least one cleaning device for a chemical cleaning of the interior of the drying chamber or for a chemical and a mechanical cleaning of the interior of the drying chamber, a cleanser and/or a disinfectant capable of being supplied to the interior of the drying chamber, distributed inside the drying chamber and removed from the drying chamber through the cleaning device.

2. The device as recited in claim 1 wherein the cleaning device comprises at least one cleansing nozzle and/or at least one cleansing brush.

3. The device as recited in claim 2 wherein the cleaning device includes the cleansing nozzle, the cleansing nozzle being a spraying ball, a deflection nozzle, a rotary nozzle, a jet nozzle or a double-jet nozzle.

4. The device as recited in claim 1 wherein the cleaning device comprises a plurality of cleansing nozzles and/or cleansing brushes, at least one of the cleansing nozzles and/or at least one of the cleansing brushes arranged in each corner of the drying chamber.

5. The device as recited in claim 4 wherein the cleansing nozzles and/or cleansing brushes are arranged in fixed positions in the interior of the drying chamber and/or the device comprises frame elements with rotating cleansing brushes mounted movably to the frame elements so that the rotating cleansing brushes can be moved into different positions within the drying chamber to contacting surfaces for cleaning.

6. The device as recited in claim 1 further comprising at least one reservoir with the cleanser and/or at least one reservoir with the disinfectant being assigned to the cleaning device and/or the cleaning device comprising at least one connection to a water supply.

7. The device as recited in claim 1 further comprising a controller assigned to the cleaning device, the cleaning device controllable manually and/or automatically via the controller.

8. The device as recited in claim 6 wherein the cleaning cycle and/or the cleaning process is adjustable and controllable by the controller.

9. The device as recited in claim 1 further comprising a lock for the inlet opening and the outlet opening of the drying chamber.

10. The device as recited in claim 1 further comprising a suction device for water and/or for the cleanser.

11. The device as recited in claim 1 wherein the transport system is a bottle transport system, the containers being bottles.

12. A method for cleaning of a device for drying containers as recited in claim 1, the method comprising:
injecting the at least one cleanser and/or disinfectant into the drying chamber;
distributing the at least one cleanser and/or disinfectant within the drying chamber; and
subsequently removing the at least one cleanser and/or disinfectant from the drying chamber through the cleaning device.

13. The method as recited in claim 12 wherein the following cleaning steps are performed automatically and/or controlled inside the drying chamber:
injecting water into the drying chamber through the cleaning device to wet interior wall surfaces;
subjecting the interior of the drying chamber to the cleanser and/or the disinfectant via injection into the drying chamber through the cleaning device;
exposing the interior wall surfaces inside the drying chamber to the cleanser and/or the disinfectant for a defined time;
rinsing the interior of the drying chamber to remove the cleanser and/or disinfectant;
re-rinsing the interior of the drying chamber;
blowing air through the at least one air supply opening; and/or
blowing air through the cleansing nozzles into the interior of the drying chamber.

14. The method as recited in claim 12 wherein air is continuously blown into the drying chamber through the at least one air supply opening during the whole cleaning process.

15. The method as recited in claim 14 wherein the drying air is generated with a blower, and the power of the blower is reduced during the cleaning process.

16. The method as recited in claim 15 wherein the power of the blower is reduced up to 80% compared to the power of the blower during a normal container drying process.

17. The method as recited in claim 12 wherein the cleaning process is controlled by a controller coupled to a lock, the controller controlling the lock before the start and after the end of the cleaning process to ensure that the inlet opening and the outlet opening for the containers are closed by the lock during the duration of the cleaning process and further ensuring that the inlet opening and the outlet opening for the containers are re-opened after the end of the cleaning process.

18. The method as recited in claim 12 wherein the cleaning process is automatically performed at pre-set time intervals, a controller stopping a further supply of containers into the drying chamber before the start of the cleaning process.
